(19) United States
(12) Patent Application Publication
(10) Pub. No.: US 2025/0332802 A1
(43) Pub. Date: Oct. 30, 2025

(54) TRANSFER RING, TIRE BUILDING ASSEMBLY AND METHOD FOR TRANSFERRING ONE OR MORE TIRE COMPONENTS

(71) Applicant: VMI Holland B.V., EPE (NL)

(72) Inventors: Anne-Per Joseph Hendrik VAN DER KOLK, EPE (NL); Clemens Jozef Anton ELFERINK, EPE (NL)

(21) Appl. No.: 18/871,430

(22) PCT Filed: Jun. 12, 2023
(86) PCT No.: PCT/NL2023/050324

§ 371 Date: Dec. 3, 2024

(30) Foreign Application Priority Data
Jun. 29, 2022 (NL) 2032313

(51) Int. Cl. B29D 30/26; B29D 30/24

(52) U.S. Cl. CPC B29D 30/2607; B29D 30/244

(57) ABSTRACT

Disclosed is a transfer ring for transferring one or more tire components, wherein the transfer ring has a frame that extends circumferentially about a central axis defining a central aperture for receiving a tire building drum, wherein the transfer ring has a plurality of holding members distributed circumferentially about the central axis for holding the one or more tire components, wherein the transfer ring further has a radial drive for moving the holding members with respect to the frame in a contraction direction and an expansion direction, wherein the radial drive has, for at least one holding member of the plurality of holding members, a first drive member that is arranged for translational movement with respect to the frame and a second drive member that is arranged for translational movement with respect to the first drive member.

### BACKGROUND

The invention relates to a transfer ring, a tire building assembly comprising said transfer ring, and a method for transferring one or more tire component.

A known tire building assembly comprises a carcass drum for receiving a plurality of tire components to form a tire carcass. The assembly comprises two bead set rings to apply a bead apex around the tire carcass. The assembly further comprises a magnet ring and two fork rings to lift the center part and the axial ends, respectively, of the tire carcass from the carcass drum and to transfer the tire carcass to a shaping drum. The bead set rings are located on either side of the magnet ring and between the respective fork rings in the axial direction of the carcass drum.

Each fork ring comprise a plurality of circumferentially distributed forks, lifters or scoops which are insertable between the carcass package and the carcass drum to lift said carcass package from the carcass drum. The fork ring comprises pneumatic actuators for moving the lifters in the radial direction with respect to the drum axis to lift the tire carcass from the circumferential surface of the carcass drum and to stretch the tire carcass in the radial direction before applying said tire carcass onto the shaping drum.

### SUMMARY OF THE INVENTION

Although the lifters of the known fork ring can be retracted to allow for the insertion of a bead gripper to supply a bead to the bead setter, said retraction takes time. In particular, the bead gripper or a robot head carrying said bead gripper may collide with the lifters of the known fork ring when they are not yet fully retracted. Hence, the bead gripper has to wait until it can be confirmed that all of the lifters have been fully retracted. A large stroke of the lifters is necessary to allow said lifters to be sufficiently displaced between the innermost radial position and the radial outward position to allow for the insertion of different bead grippers corresponding to a large variety of bead sizes. Said large stroke significantly reduces the process efficiency.

Additionally, the stroke requires the fork ring to be sufficiently large to accommodate the lifters both in the innermost radial position and the radial outward position.

Moreover, the pneumatic actuators can only be actuated over the entire stroke thereof. When a carcass drum and/or a shaping drum with a different diameter is used, an additional process step is needed to set, adjust or recalibrate said stroke to the alternative diameter of the carcass drum and/or the shaping drum.

It is an object of the present invention to provide a transfer ring, a tire building assembly comprising said transfer ring, and a method for transferring one or more tire components which can overcome at least one of the abovementioned disadvantages.

According to a first aspect, the invention provides a transfer ring for transferring one or more tire components, wherein the transfer ring comprises a frame that extends circumferentially about a central axis defining a central aperture for receiving a tire building drum, wherein the transfer ring comprises a plurality of holding members for holding the one or more tire components during transfer of said one or more tire components by the transfer ring, wherein said holding members are distributed circumferentially about the central axis, wherein the transfer ring further comprises a radial drive for moving the holding members with respect to the frame in a contraction direction towards the central axis and in an expansion direction away from the central axis, wherein the radial drive comprises, for at least one holding member of the plurality of holding members, a first drive member that is arranged for translational movement with respect to the frame with at least a vector component in the contraction direction and the expansion direction and a second drive member, supported by the first drive member, that is arranged for translational movement with respect to the first drive member with at least a vector component in the contraction direction and the expansion direction.

In other words, the first drive member and the second drive member provide a telescopic extension mechanism for the holding member. Hence, a displacement of a holding member with respect to the frame between an radially expanded state and a radially contracted state can be subdivided in a displacement of the first drive member relative to the frame and a displacement of the second drive member relative to the first drive member. In other words, the movement of the holding member relative to the frame is a superposition of the movements of the first drive member and the second drive member. Accordingly, the individual strokes of the first drive member and the second segment can be smaller than the resulting stroke of the holding member. Hence, the transfer ring can be constructed more compactly. Additionally, the first drive member and the second drive member can be moved simultaneously. Hence, a movement of the holding members with respect to the frame, which is a superposition of the individual movements of the first drive member and the second drive member, can be more efficient. Accordingly, the process efficiency can be improved.

In an embodiment thereof, the radial drive comprises a first transmission that is arranged for mechanically coupling a movement of the first drive member with respect to the frame to a movement of the second drive member with respect to the first drive member. In other words, the first transmission is arranged to impart a movement to the second drive member with respect to the first drive member in response to a movement of the first drive member with respect to the frame. Hence, the first drive member and the second drive member can be driven using a single drive or actuator.

In a further embodiment thereof, the first transmission is arranged to impart a movement to the second drive member in the contraction direction in response to a movement of the first drive member in the contraction direction, and wherein the first transmission is arranged to impart a movement to the second drive member in the expansion direction in response to a movement of the first drive member in the expansion direction. In other words, a movement of the first drive member relative to the frame in either the expansion direction or the contraction direction causes a movement of the second drive member relative to the first drive member in the same direction. Hence, a displacement of the first drive member relative to the frame causes the holding member to be displaced with respect to the frame over the sum of the displacement of the first drive member relative to the frame and the displacement of the second drive member relative to the first drive member.

In a further embodiment, a transmission ratio between the movement of the first drive member with respect to the frame and the movement of the second drive member with respect to the first drive member is fixed. Hence, a displacement of the first drive member relative to the frame can cause a proportional displacement of the second drive member relative to the first drive member. Accordingly, the displacement of the holding member relative to the frame can be proportional to the displacement of the first drive member relative to the frame.

In a preferred embodiment thereof, the transmission ratio between the movement of the first drive member with respect to the frame and the movement of the second drive member with respect to the frame is at least 2:1. In other words, the transmission ratio between the movement of the first drive member with respect to the frame and the movement of the second drive member with respect to the first drive member can be equal to one or substantially equal to one. Hence, a displacement of the first drive member relative to the frame can cause an equal displacement of the second drive member relative to the first drive member. Accordingly, the displacement of the holding member relative to the frame can be twice the displacement of the first drive member relative to the frame.

In a further embodiment, the first transmission comprises a belt that is freely rotatable with respect to the first drive member, wherein the belt is, at a first side of the first drive member, fixedly connected to the frame, and wherein the belt is, at a second side of the first drive member opposite to the first side, fixedly connected to the second drive member, such that a movement of the first drive member with respect to the frame causes the second drive member to move with respect to the first drive member in the same direction. Preferably, the belt extends at least partly in the radial inward direction. In other words, a translation of the first drive member relative to the frame in the direction of the belt can cause the belt to rotate with respect to the first drive member. Accordingly, said rotation of the belt can drive a translation of the second drive member relative to the first drive member in the direction of the belt. Alternatively, the first transmission may for example comprise one or more freely rotatable gears arranged on the first drive belt and associated gear racks on the second drive member and the frame, respectively.

In an embodiment thereof, the second drive member extends in line with the belt. Hence, forces acting on the holding member in the radial inward direction and/or the radial outward direction can act in line with the belt.

In an alternative embodiment thereof, the second drive member extends parallel or offset to the belt. In other words the second drive member and the belt can extend side by side. Hence, the assembly of the first drive member and the second drive member can be more compact.

In a further embodiment, the radial drive comprises an actuator for actuating the movement of the first drive member with respect to the frame, and wherein the radial drive further comprises a second transmission for mechanically coupling a movement of the coupling the actuator to the movement of the first drive member.

In an embodiment thereof, the second transmission comprises a gear rack that is fixedly connected to the first drive member and an associated pinion that is mounted to the frame, wherein the pinion is mechanically coupled to the actuator. Hence, a rotational movement of the actuator can be converted to a radial displacement of the first drive member.

In a further embodiment, the second transmission further comprises a planet gear for engaging multiple pinions in rotation simultaneously, and wherein the actuator is arranged to drive the planet gear in rotation. Hence, a single actuator can drive the movement of multiple first drive members. Moreover, the actuator can drive said first drive members to move simultaneously.

In a further embodiment, the actuator is a rotational drive, preferably a servomotor or a stepper motor. The rotational drive or servomotor can set or adjust the stroke and/or the inner radius of the holding member to a diameter of a building drum without the need to interrupting the tire building process, i.e. without the need to set or adjust the stroke of the holding member at the surface of said tire building drum itself. Hence, the rotational drive or servomotor can set or adjust said inner radius without interrupting the tire building process, e.g. while a tire component is being applied to said tire building drum or while a further tire component is being applied to a tire component already present on the tire building drum.

In a further embodiment, the radial drive comprises a first actuator for driving the movement of the first drive member with respect to the frame and a second actuator for driving the movement of the second drive member with respect to the first drive member. Hence, the first drive member and the second drive member can be driven individually and/or simultaneously in the expansion direction and the contraction direction, respectively.

In an embodiment thereof, the radial drive further comprises a control unit that is electronically or functionally connected to the first actuator and the second actuator, wherein the control unit is arranged for electronically coupling a movement of the first drive member with respect to the second drive member to a movement of the first drive member with respect to the frame. Hence, the control unit can control the movement of the first drive member and the movement of the second drive member to be proportional.

In a further embodiment thereof, the control unit is arranged to control the first actuator and the second actuator such that a ratio between the movement of the first drive member with respect to the frame and the movement of the second drive member with respect to the first drive member is fixed. Preferably, said ratio is one. Hence, the control unit can control the displacement of the first drive member relative to the frame to be proportional and/or equal to the displacement of the second drive member relative to the first drive member. Accordingly, the control unit can control the displacement of the holding member relative to the frame to be proportional to the displacement of the first drive member relative to the frame. In particular, the control unit can control the displacement of the holding member relative to the frame to be twice the displacement of the first drive member relative to the frame.

In a further embodiment thereof, at least one of the first actuator and the second actuator is a rotational drive, preferably a servomotor or a stepper motor. The rotational drive or servomotor can set or adjust the stroke and/or the inner radius of the holding member to a diameter of a building drum without the need to interrupting the tire building process, i.e. without the need to set or adjust the stroke of the holding member at the tire building drum itself. Hence, the rotational drive or servomotor can set or adjust said inner radius without interrupting the tire building process, e.g. while a tire component is being applied to said tire building drum.

In a further embodiment, the first drive member is linearly movable with respect to the frame in the radial and the inward direction radial outward direction. Additionally or alternatively, the second drive member is linearly movable with respect to the first drive member in the radial inward direction and the radial outward direction. In other words the contraction direction can be equal to the radial inward direction and the expansion direction can be equal to the radial outward direction. Accordingly, the holding members can be moved or displaced in a radial direction. Hence, friction between the one or more tire components and the tire building drum or between the one or more tire components and the holding members in the circumferential direction or the axial direction can be prevented.

In a further embodiment, the holding member is supported by the second drive member. Preferably, the holding member is fixedly connected to the second drive member. Ultimately, the holding member and the second drive member can be formed as a single part. Hence, the holding member can be reliably mounted or connected to the second drive member. Accordingly, tolerances between the holding member and the second drive member can be reduced or diminished. Hence, the transfer ring can more accurately retain the one or more tire components.

In a further embodiment, in an expanded state, the first drive member and the second drive member extend outside of the central aperture in the radial outward direction. In other words, the first drive member and second drive member do not extend within said radial aperture when in the expanded state. Hence, a clearance space is created within the radius of the central aperture. A clearance space within the radius of the central aperture of a fork ring can for example facilitate supplying a bead or bead-apex to a bead setter located next to said fork ring.

In a further embodiment, the holding member comprises a fork, a scoop or a lifter that is arranged to be inserted between a circumferential surface of the tire building drum and the one or more tire components. In other words, the transfer ring is a fork ring.

In a preferred embodiment, the radial drive comprises, for each holding member of the plurality of holding members, a first drive member and a second drive member, supported by a respective first drive member.

In an embodiment thereof, the radial drive is arranged to drive the first drive members simultaneously and/or synchronously in the contraction direction and the expansion direction.

According to a second aspect, the present invention relates to a tire building assembly for transferring one or more tire components, wherein the assembly comprises two first transfer rings for lifting a respective axial end of the one or more tire components, two second transfer rings, positioned between the two first transfer rings, for retaining a bead-apex, and a third transfer ring, positioned between the two second transfer rings, for retaining a central portion of the one or more tire components, wherein at least one of the first transfer rings, the second transfer rings and the third transfer ring is a transfer ring according to any one of the preceding claims.

The tire building assembly comprises the transfer ring according to the first aspect of the invention and, thus, comprises the same advantages as mentioned above.

According to a third aspect, the present invention provides a method for transferring one or more tire components using a transfer ring according to the first aspect of the invention, wherein the method comprises the steps of moving the holding members relative to the frame in the contraction direction and/or the expansion direction.

The method incorporates the transfer ring according to the first aspect of the invention and, thus, comprises the same advantages as mentioned above.

In an embodiment, the holding members are moved relative to the frame in the contraction direction and/or the expansion direction while the tire building drum is received within the central aperture of the transfer ring.

In a further embodiment, a radial position of the holding members is being adjusted to a diameter of the tire building drum while the transfer ring is spaced apart from said tire building drum along the central axis.

In a further embodiment, the holding members are inserted at a position radially inward of the one or more tire components in an axial direction parallel to the central axis while the transfer ring is spaced apart from said tire building drum in said axial direction. Alternatively, the holding members are inserted between the one or more tire components and the circumferential surface while moving the transfer ring away from the tire building drum in the axial direction. In other words, the tire components can be moved away from the tire building drum before the holding members are inserted. Hence, idle time of the transfer rings at the tire building drum can be reduced. Thus process efficiency van be further increased.

In a further embodiment, the holding members are moved relative to the frame in the contraction direction and/or the expansion direction while non-transfer-related operations are performed on and/or by the tire building drum. Said non-transfer related operations may for example include: expanding and/or contracting the tire building drum; applying one or more tire components around the tire building drum; stitching one or more tire components on said tire building drum; turn-up of one or more tire components at the tire building drum; and/or shaping the tire components at the tire building drum. In other words, said non-transfer-related operations do not have to be ceased to enable an adjustment of the holding members in the expansion direction or the contraction direction. Hence process efficiency can be improved.

According to a fourth, unclaimed aspect, the invention relates to a transfer ring for transferring one or more tire components, wherein the transfer ring comprises a frame that extends circumferentially about a central axis defining a central aperture for receiving a tire building drum, wherein the transfer ring comprises a plurality of holding members for holding the one or more tire components, wherein said holding members are distributed circumferentially about the central axis, wherein the transfer ring further comprises a radial drive that is arranged to move the holding members with respect to the frame in a contraction direction towards the central axis and in an expansion direction away from the central axis, wherein the radial drive comprises an actuator for actuating a translational movement of the holding members with respect to the frame with at least a vector component in the contraction direction and the expansion direction, wherein the actuator is a linear drive. Preferably, the actuator is a linear servomotor, such as a servo controlled spindle.

The linear servomotor can set or adjust the stroke and/or the inner radius of the holding member to a diameter of a building drum without the need to interrupting the tire building process, i.e. without the need to set or adjust the stroke of the holding member at the surface of said tire building drum itself. Hence, the linear servomotor can set or adjust said inner radius without interrupting the tire building process, e.g. while a tire component is being applied to said tire building drum.

In an embodiment thereof, the radial drive further comprises a transmission for mechanically coupling a movement of the actuator to the movement of the holding members. Preferably, transmission the is arranged to convert a rotational movement of the actuator into a linear and/or translational movement of the holding members.

In a further embodiment thereof, the transmission comprises a gear rack that is fixedly connected to or with respect to the holding members and an associated pinion that is mounted to the frame, wherein the pinion is mechanically coupled to the actuator.

In a further embodiment thereof, the transmission further comprises a planet gear for engaging multiple pinions in rotation simultaneously, and wherein the actuator is arranged to drive the planet gear in rotation. In other words, multiple holding members or all holding members can be driven by a single planet gear. Accordingly, said holding members can be driven by a single actuator. Hence, the holding members can be driven simultaneously without the need of adjusting

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows a tire building assembly comprising a transfer ring according to an exemplary embodiment of the present invention;

FIGS. 2A-2E show exemplary steps of a method of transferring a tire component according to the present invention;

FIGS. 3 and 4 show a front view of the transfer ring of FIG. 1 in a contracted state and an expanded state, respectively;

FIG. 5 shows a detailed view of a radial drive of the transfer ring according to the circle V in FIG. 4;

FIG. 6 shows a cross-sectional view of the radial drive according to the line VI-VI in FIG. 5;

FIG. 7 shows the radial drive of FIG. 5 in an intermediate state;

FIG. 8 shows a cross-sectional view of the radial drive according to the line VIII-VIII in FIG. 7;

FIG. 9 shows the radial drive of FIG. 5 in the expanded state;

FIG. 10 shows a cross-sectional view of the radial drive according to the line X-X in FIG. 9;

FIG. 11 shows an alternative radial drive from the viewpoint of FIG. 5; and

FIG. 12 shows a further alternative radial drive from the viewpoint of FIG. 5.

### DETAILED DESCRIPTION OF THE INVENTION

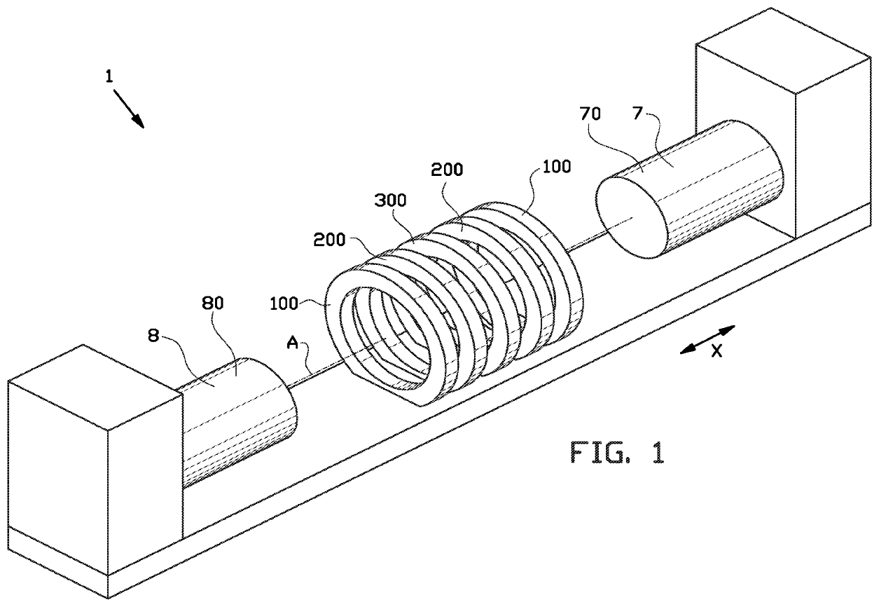

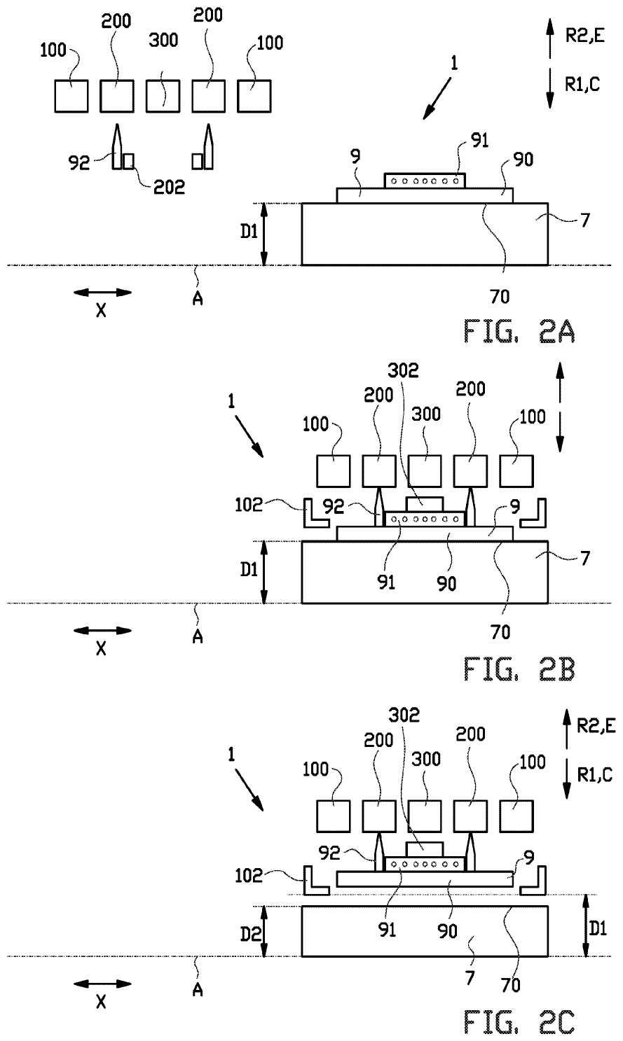

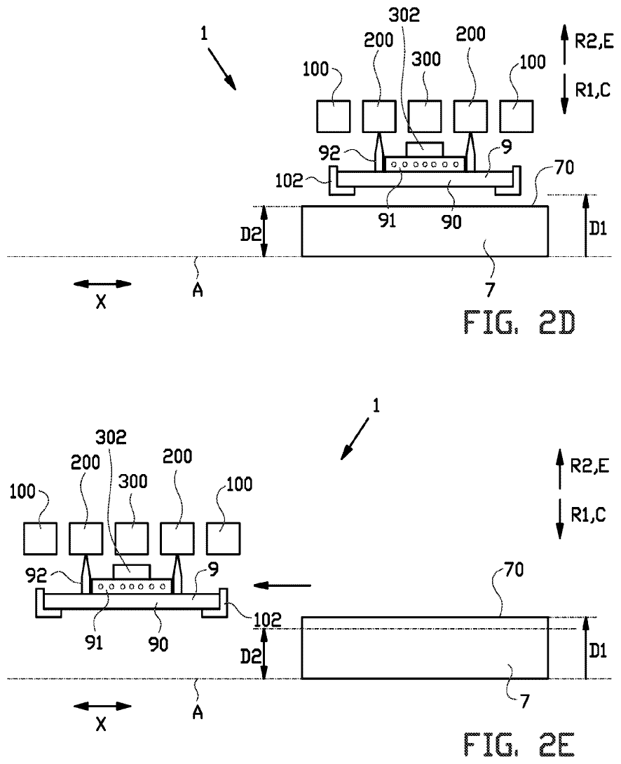

FIGS. 1 and 2A-2E show a tire building assembly 1 according to an exemplary embodiment of the present invention. The tire building assembly 1 comprises a first tire building drum 7 and a second tire building drum 8. The first tire building drum 7 and the second tire building drum 8 are each arranged for receiving one or more tire components 90, 91, 92 to form at least a part of a green tire. The tire building assembly 1 further comprises a set of transfer rings 100, 200, 300 for transferring the one or more tire components 90, 91, 92 between the first tire building drum 7 and the second tire building drum 8. In this particular embodiment, the transfer rings 100, 200, 300 are movable with respect to the first tire building drum 7 and the second tire building drum 8 in an axial direction X. Alternatively, the first tire building drum 7 and the second tire building drum 8 may be movable with respect to the transfer rings 100, 200, 300. Preferably, the first tire building drum 7, the second tire building drum 8 and the transfer rings 100, 200, 300 are in line or arranged to be aligned along a central axis A extending in the axial direction X.

In this particular embodiment, the first tire building drum 7 is a carcass drum. The first tire building drum 7 is rotatable about the central axis A. The first tire building drum 7 comprises a cylindrical or substantially cylindrical circumferential receiving surface 70 for receiving a plurality of tire components 90, 91, 92 to form a green tire carcass 9. In this particular example, said tire components 90, 91, 92 include an inner liner 90, a cord reinforced breaker ply 91 and two bead-apexes 92.

The circumferential receiving surface 70 of the first tire building drum 7 extends circumferentially about the central axis A. The first tire building drum 7, in particular the circumferential receiving surface 70 of said first tire building drum 7, is expandable and retractable in a radial outward direction R2 and a radial inward direction R1 opposite to said radial outward direction R2, respectively. In particular, the first tire building drum 7 is retractable from a first diameter D1 to a second diameter D2 smaller than the first diameter D1. The radial inward direction R1 and the radial outward direction R2 extend perpendicular to the central axis A. Mechanisms for expanding and retracting carcass drums are known per se.

The second tire building drum 8 is a shaping drum. The second tire building drum 8 comprises a circumferential shaping surface 80 extending circumferentially about the central axis A. The second tire building drum 8 may further comprise one or more bladders and/or a plurality of turn-up arms (not shown) for shaping the green tire carcass 90 received from the first tire building drum 7 and/or for folding the ends of the green tire carcass 90 around the bead-apex 92.

In the embodiment as shown in FIGS. 1 and 2A-2E, the set of transfer rings 100, 200, 300 comprises two first transfer rings 100, two second transfer rings 200 between said first transfer rings 100, and one third transfer ring 300 between the second transfer rings 200.

In this particular embodiment, the first transfer rings 100 are fork rings. As is shown in FIGS. 2A-2E, said first transfer rings 100 comprise a plurality of first holding members 102 that are distributed circumferentially about the central axis A. Said first holding members 102 comprise forks or scoops that are insertable between the circumferential receiving surface 70 of the first drum 7 and the green tire carcass 9 to lift said green tire carcass 9 from the circumferential receiving surface 70 of the first drum 7.

As is best shown in FIG. 2A, the second transfer rings 200 are bead setters. The second transfer rings 200 are each arranged for receiving a bead or bead-apex 92, e.g. manually or from a robot arm (not shown). The second transfer rings 200 each comprise a plurality of second holding members or bead holding members 202 for holding or retaining a respective one of the bead-apexes 92. Said bead holding members 202 are distributed circumferentially about the central axis A. The bead holding members 202 may for example comprise one or more magnets. The second transfer rings 200 are arranged for placing the bead or bead-apex 92 on the one or more tire components, e.g. an inner liner 90, that are already placed on the first tire building drum 7.

The third transfer ring 300 is arranged for retaining a central part of the green tire carcass 90. The third transfer ring 300 comprises a plurality of third holding members or central holding members 302 for retaining said central part of the green tire carcass 9. Said central holding members 302 are distributed circumferentially about the central axis A. In this particular embodiment, the third transfer ring 300 is a magnet ring, i.e. the central holding members 302 comprise one or more magnets for retaining a steel cord reinforced tire component, such as the breaker ply 91. Additionally or alternatively, the central holding members 302 may for example comprise vacuum cups or bores for retaining the central part of the green tire carcass 9.

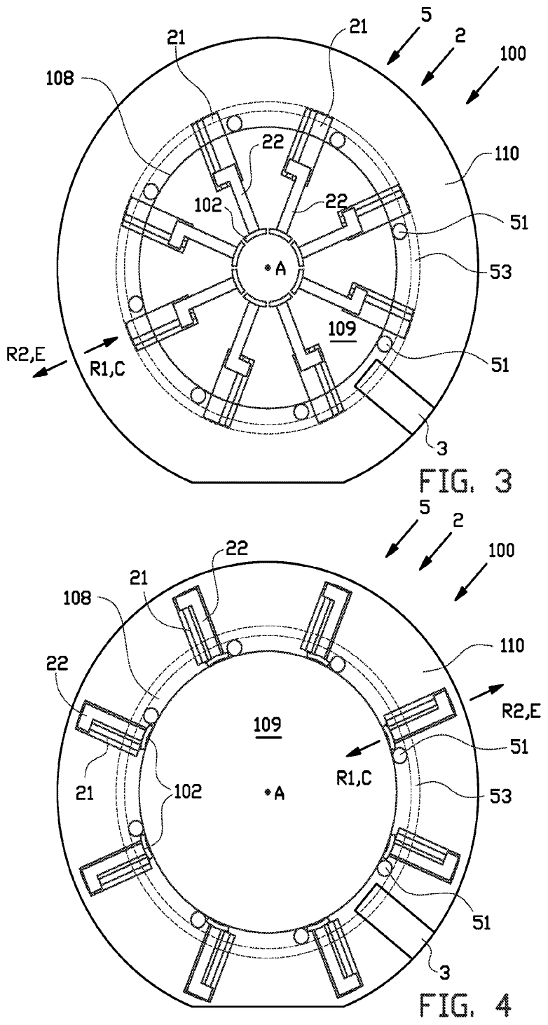

The first transfer ring 100 is shown in more detail in FIGS. 3 and 4. The first transfer ring 100 comprises a frame 110 with an inner edge 108 defining a central aperture 109. The inner edge 108 of the frame 110 extends circumferentially about the central axis A. Preferably, the inner edge 108 is at least partially circular. The first holding members 102 are supported with respect to the frame 110. Said first holding members 102 are movable between a contracted state, as is shown in FIG. 3 and an expanded state, as is shown in FIG. 4. In particular, the first holding members 102 are movable in an expansion direction E from the contracted state towards the expanded state. Said expansion direction E comprises at least a vector component in the radial outward direction R2. In this particular embodiment, the expansion direction E corresponds to the radial outward direction R2. The first holding members 102 are further movable in a contraction direction C from the expanded state towards the contracted state. Said contraction direction C comprises at least a vector component in the radial inward direction R1. In this particular embodiment, the contraction direction C corresponds to the radial inward direction R1. Preferably, in the expanded state, the holding member 102 are located outside the inner rim 108 of the frame 110 in the radial outward direction R2.

The first transfer ring 100 further comprises a radial drive 2 for moving or displacing the first holding members 102 in the expansion direction E and the contraction direction C. In this particular embodiment, the radial drive 2 comprises for each holding member 102 a first drive member 21 that is movable with respect to the frame 110 and a second drive member 22 that is movable with respect to the first drive member 21. In the embodiment as shown, the first drive member 21 is movable with respect to the frame in the contraction direction C or the radial inward direction R1, and in the expansion direction E or the radial outward direction R2. Accordingly, the second drive member 22 is movable with respect to the first drive member 21 in the contraction direction C or the radial inward direction R1, and in the expansion direction E or the radial outward direction R2. Alternatively, the first drive member 21 and the second drive member 22 may be movable in a direction different from the contraction direction C and the expansion direction E, respectively.

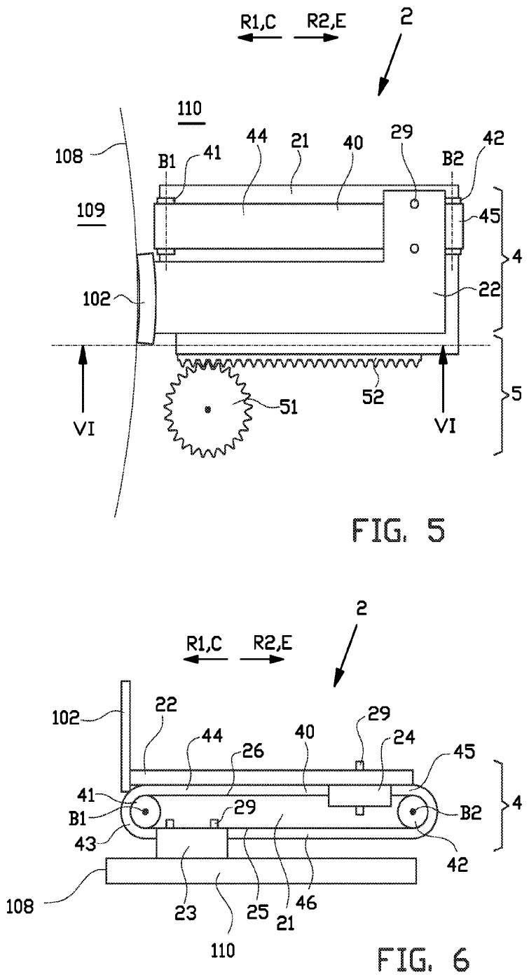

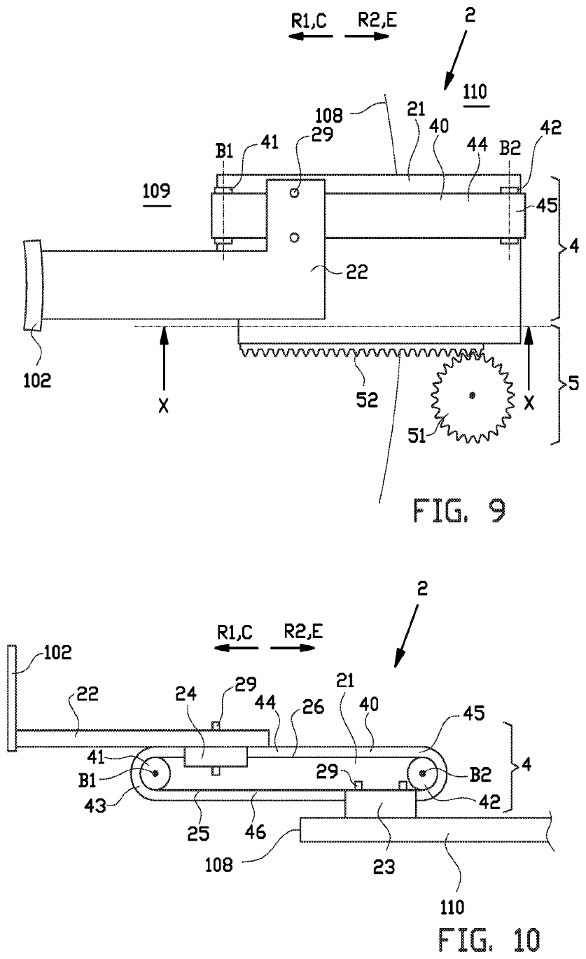

As is shown in FIGS. 5-10, the radial drive 2 comprises a first transmission 4 for mechanically coupling the movement of the first drive member 21 with respect to the frame to the movement of the second drive member 22 with respect to the first drive member 21. In other words, the first transmission 4 directly and/or mechanically links the movement of the second drive member 22 to the movement of the first drive member 21. In particular, the first transmission 4 is arranged to impart a movement to the second drive member 22 with respect to the first drive member 21 in response to or as a result of a movement of the first drive member 21 with respect to the frame 110.

The first drive member 21 and the second drive member 22 are guided relative to frame 110 and the first drive member 21, respectively, by linear guides (not shown). Said linear guides may for example comprise one or more guide rails.

As is further shown in FIGS. 5-10, a displacement of the first drive member 21 relative to the frame 110 in the radial inward direction R1 results in a displacement of the second drive member 22 relative to the first drive member 21 in the radial inward direction R1 as well. Accordingly, a displacement of the first drive member 21 relative to the frame 110 in the radial direction R2 results in a displacement of the second drive member 22 relative to the first drive member 21 in the radial outward direction R2. In other words, a displacement of the first drive member 21 relative to the frame 110 results in a displacement of the second drive member 22 relative to the frame in the same direction R1, R2.

The first transmission 4 is arranged such, that a transmission ratio between the movement of the first drive member 21 with respect to the frame 110 and the movement of the second drive member 22 with respect to the first drive member 21 is fixed. In other words, a movement of the first drive member 21 with respect to the frame 110 is directly and/or linearly related to a movement of the second drive member 22 relative to the first drive member 21. Preferably, a ratio between the movement of the second drive member 22 relative to the frame 110 and the first drive member 21 relative to the frame 110 is at least 2:1. More preferably, said ratio is equal to 2:1. In other words, the transmission ratio between the movement of the first drive member 21 relative to the frame 110 and the second drive member 22 relative to the first drive member 21 may be equal to or substantially equal to one.

As is best shown in FIGS. 6, 8 and 10, the first transmission 4 comprises a belt 40. Said belt 40 is looped around a first pulley 41 and a second pulley 42. The belt 40 may for example be a rubber belt and/or a toothed belt. The belt extends in or substantially in the expansion direction E. The first pulley 41 and the second pulley 42 are mounted to the first drive member 21. The first pulley 41 is freely rotatable about a first pulley axis B1 that extends transverse or perpendicular to the expansion direction E. Preferably, the first pulley axis B1 extends transverse or perpendicular to the axial direction X. The second pulley 42 is freely rotatable about a second pulley axis B2 that extends parallel or substantially parallel to the first pulley axis B1. The first pulley 41 and the second pulley 42 are spaced apart in the expansion direction E. In particular, the second pully 42 is located at a distance downstream of the first pulley 41 in the expansion direction E. In other words, the first pulley 41 is located at a distance downstream of the second pulley 42 in the contraction direction C.

The belt 40 is, at a first side 25 of the first drive member 21, connected to the frame 110. The first side 25 of the first drive member 21 is facing the frame 110. In particular the first transfer ring 100 comprises a first attachment member 23 for attaching the belt 40 to the frame 110. At a second side 26 of the first drive member 21 opposite to the first side 25, the belt 40 is connected to the second drive member 22. The second side 25 of the first drive member 21 faces away from the frame 110. The second drive member 22 comprises a second attachment member 26 for attaching said second drive member 22 to the belt 40. Preferably, the first attachment member 25 and the second attachment member 26 attach the frame and the second drive member 22, respectively, to the belt 40 by clamping force. Said clamping force may for example be exerted by fasteners 29.

As is best shown in FIGS. 6, 8 and 10, the belt 40 comprises a first belt part 43, a second belt part 44, a third belt part 45 and a fourth belt part 46. The first belt part 43 extends between the first attachment member 23 and the first pulley 41. The second belt 44 part extends between the second attachment member 24 and the first pulley 41. The third belt part 45 extends between the second attachment member 22 and the second pulley 42. The fourth belt part 46 extends between the first attachment member 23 and the second pulley 42.

FIGS. 4, 5 and 6 show the radial drive 2 in the expanded state. As is shown in FIG. 6, the first attachment member 23 is located at the first pulley 41. The second attachment member 24 is located at the second pulley 42. In said expanded state, the lengths of the first belt part 43 and the third belt part 45, respectively, are at a minimum. Accordingly, the lengths of the second belt part 44 and the fourth belt part 46, respectively, are at a maximum.

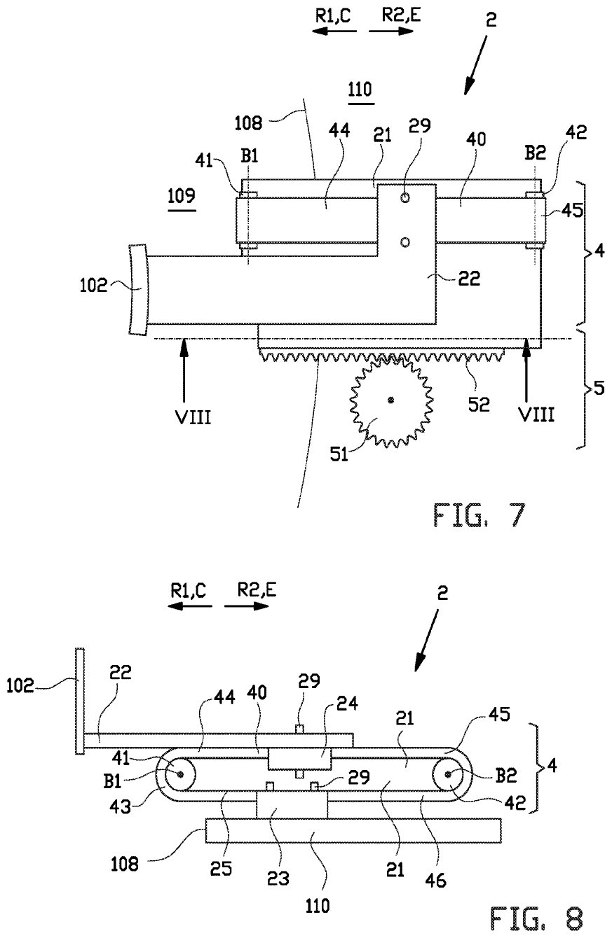

FIGS. 7 and 8 show the radial drive 2 in an intermediate state between the extended state and the contracted state. The first drive member 21 has been displaced relative to the frame 110 in the contraction direction C over a first distance. As is best shown in FIG. 8, the displacement of the first drive member 21 relative to the frame 110 in the contraction direction C has caused the belt 40 to rotate about the first pulley 41 and the second pulley 42 in anti-clockwise direction. The lengths of the first belt part 43 and the third belt part 45, respectively, have been increased by the first distance. Accordingly the lengths of the second belt part 44 and the fourth belt part 46 have been decreased by the first distance. In other words, the second attachment member 24 has been displaced relative to the first drive member by the first distance. Accordingly, the second drive member 22 has been displaced relative to the frame 110 by twice the first distance.

FIGS. 3, 9 and 10 show the radial drive 2 in the contracted state. As is shown in FIG. 10. The first drive member 21 has been displaced further in the contraction direction over a second distance. Accordingly, the displacement of the first drive member 21 relative to the frame 110 in the contraction direction C has caused the belt 40 to rotate further about the first pulley 41 and the second pulley 42 in the anti-clockwise direction. As is shown in FIG. 10, the first attachment member 23 is located at the second pulley 42. The second attachment member 24 is located at t pulley 41. In said contracted state, the lengths of the first belt part 43 and the third belt part 45, respectively, are at a maximum. Accordingly, the lengths of the second belt part 44 and the fourth belt part 46, respectively, are at a minimum.

As is shown in FIGS. 3 and 4, the first transfer ring 100 comprises an actuator 3 for driving the movement of the first drive members 21 relative to the frame 110. As is further shown in FIGS. 3-5, 7 and 9, the first transfer ring 100 comprises a second transmission 5 for coupling a movement of the actuator 3 to the movement of the first drive members 21. In particular, the second transmission 5 comprises for each first drive member 21 a pinion 51 and an associated gear rack 52. Said gear rack 52 is fixedly connected to the first drive member 21. The gear rack 52 extends in the contraction direction C. Preferably, the gear rack 52 is an integral part of the drive member 52. The pinion 51 is rotatably supported on the frame 110. In particular, the pinion 51 is rotatable about a pinion axis perpendicular to the frame 110. Said pinion axis extends in the axial direction X. The pinions 51 are located at or near the inner rim 108 of the frame 110.

As is further shown in FIGS. 3 and 4, the second transmission 5 comprises a gear ring 53 for mechanically connecting the actuator 3 to the pinions 51 associated with the first drive members 21. In the embodiment as shown, the gear ring 53 is located on the opposite side of the frame 110 as the pinions 51. Said gear ring 53 extends circumferentially about the central axis A. In particular, the gear ring 53 extends concentric to the inner rim 108 of the frame 108. The pinions 51 are each arranged on a pinion axle (not shown) that extends through the frame 110 in the axial direction X and engages the gear ring 53 such that a rotation of the gear ring 53 about the central axis A causes a rotation of the pinions 53. Said rotation of the gear ring 53, may cause the pinions 51 to rotate simultaneously, synchronously and/or in sync. In other words, a rotational movement of the gear ring 53 may cause the first drive members 21 to be moved simultaneously, synchronously, or in sync in the expansion direction E or the contraction direction C. The actuator 3 is arranged to impart a rotation on the gear ring 53.

In this particular embodiment, the actuator 3, is a rotational drive, preferably a servomotor. Alternatively, the actuator 3 may be a linear servomotor, such as a servo controlled spindle. The actuator 3 drives the gear ring 53 in rotation to affect the movement of the first drive members 21. A rotational drive or servomotor has the advantage over a pneumatic actuator that a stroke of the first drive members 21 relative to the frame 110 may be adjusted without the need of interrupting the tire building process, e.g. without the need to set or adjust the stroke of the first holding member 102 at the circumferential retaining surface 70 of the tire building drum 7. Hence, the rotational drive or servomotor can be adjusted to the first diameter D1 or the second diameter D2 of the tire building drum 7 without interrupting the tire building process.

A similar advantage may be obtained when the second drive member 22 is omitted. In other words, a rotational drive or servomotor may be provided to a transfer ring having a single drive member, i.e. a non-telescopic transfer ring (not shown), for imparting a translational movement to the first holding members 102.

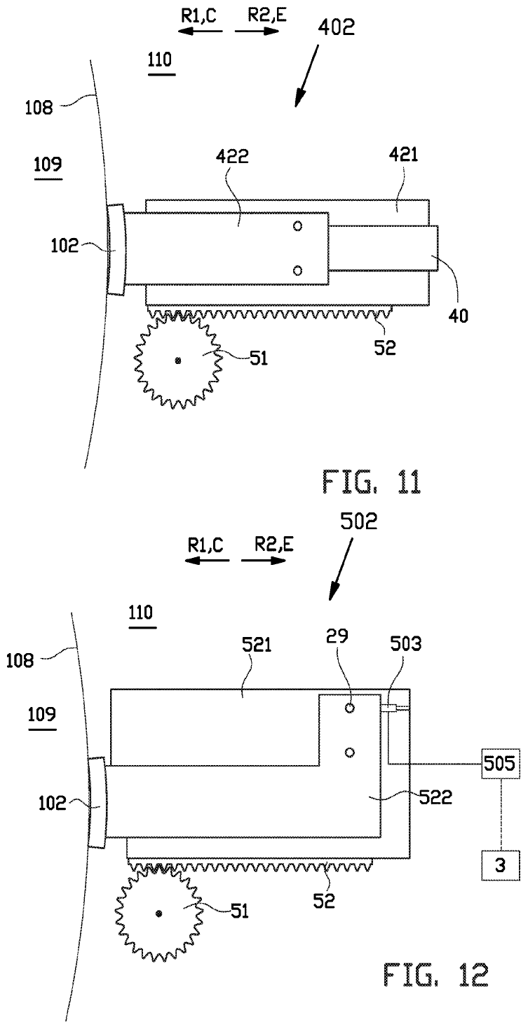

FIG. 11 shows an alternative radial drive 402 according to an alternative embodiment of the present invention. The alternative radial drive 402 differs from the previously discussed radial drive 2 in that it comprises an alternative first drive member 421 and an alternative second drive member 422. Said second drive member 422 is arranged in line with the belt 40 in the contraction direction C.

FIG. 12 shows a further alternative radial drive 502 according to a further alternative embodiment of the present invention. Said radial drive 502 differs from the previously discussed radial drives 2, 402 in that the movement of the second drive member 522 relative to the first drive member 521 is driven by a further actuator or second actuator 503. The alternative radial drive 502 further comprises a control unit 505 which is electronically and/or functionally connected to the actuator 3 and the further actuator 503. Said further actuator 503 may for example be a pneumatic cylinder or an air cylinder. Preferably, at least one of the actuator 3 and the further actuator 503 is a rotational drive or a servomotor.

The control unit 505 is arranged for electronically and/or functionally coupling a movement of the first drive member 521 with respect to the second drive member 522 to a movement of the first drive member 521 with respect to the frame 110. In particular, the control unit 505 may be arranged to control the actuator 3 and the further actuator 503 such that a ratio between the movement of the first drive member 521 with respect to the frame 110 and the movement of the second drive member 522 with respect to the first drive member 521 is fixed. Analogously to the previously discussed transmission 4, the control unit 505 is preferably arranged to drive the movement of the second drive member 522 relative to the frame 110 and the movement of the first drive member 521 relative to the frame 110 at a ratio of 2:1.

Although the abovementioned embodiments of the radial drive 2, 402, 502 have been described in relation to the first transfer ring 100, said embodiments of the radial drive 2, 402, 502 may be applied mutatis mutandis to the second transfer ring 200 and/or the third transfer ring 300. In particular, the radial drive 2, 402, 502 of either of described embodiments may be implemented in the second transfer ring 200 or bead setter to drive a movement of the second holding members or bead holding members 202 with at least a vector component in the radial inward direction R1 and the radial outward direction R2, respectively. Additionally or alternatively, the radial drive 2, 402, 502 of either of described embodiments may be implemented in the third transfer ring 300 or magnet ring to drive a movement of the third holding members or central holding members 302 with at least a vector component in the radial inward direction R1 and the radial outward direction R2, respectively.

It is further noted that the radial drive 2, 402, 502 according to any one of the abovementioned embodiments may further comprise a third drive member (not shown) that is movable with respect to the second drive member 22, 422 in a manner similar to the movement of the second drive member 22, 422 relative to the first drive member 21, 421. Preferably, the movement of said third drive member with respect to the second drive member 22, 422 is mechanically coupled to the movement of the second drive member 22, 422 with respect to the first drive member 21, 421 in a similar manner as described in any one of the previously discussed embodiments.

A method for transferring one or more tire components 90, 91, 92 will now be described using FIGS. 2A-2E and 3-10.

FIG. 2 shows step of a supplying tire components 90, 91, 92 to the first tire building drum 7. The first transfer rings 100, 200, 300 are located at a distance of the first tire building drum 7 in the axial direction 7. The inner liner 90 and the cord reinforced breaker ply 91 have been applied to the first tire building drum 7. In particular, said inner liner 90 and said breaker ply have been applied around the circumferential retaining surface 70 of said first tire building drum 7.

The fork rings or first transfer rings 100 and the third transfer ring 300 are in the expanded states thereof. In particular, as is shown in FIGS. 4, 5 and 6, the first transfer rings 100 are in the expanded state, i.e. the forks, scoops or first holding members 102 are expanded past the inner rim 108 of the frame 110 in the expansion direction E.

The two bead-apexes 92 have been supplied to the respective bead setters or second transfer rings 200. In particular, said bead-apexes 92 have been supplied to the respective second transfer rings 200 through respective the central apertures 109 of the adjacent first transfer rings 100. The bead-apexes 92 are retained by the second holding members 202. Preferably, the second holding member 202 have been set or adjusted to a diameter of the bead-apexes 92 by moving said second holding member 202 in the contracting direction C using the radial drive 2 as described above.

Subsequently, the transfer rings 100, 200, 300 are moved in the axial direction X towards the first tire building drum 7 and into the position as shown in FIG. 2B. Preferably, the transfer rings 100, 200, 300 are moved in the axial direction X simultaneously or synchronously. The bead-apexes 92 have been placed on the inner liner 90.

As is further shown in FIG. 2B, the third holding members 302 are moved from the expanded state thereof in the radial inward direction R1. The third holding members 302 have been moved into contact with a central portion of the green tire carcass 9. In particular, the third holding members 302 have been moved into contact with the breaker ply 91. The third holding members 302 are retaining the breaker ply 91 my a magnetic retaining force acting on the reinforcement cords in said breaker ply 91.

The forks, scoops, lifters or first holding members 102 have been moved from the expanded state thereof in the contraction direction C. In this particular embodiment, the first holding members 102 have been moved towards the circumferential retaining surface 70 of the first tire building 70.

As is shown in FIG. 2C, the first tire building drum 7 has been contracted in the radial inner direction R1 from the first diameter D1 to the second diameter D2. The green tire carcass 9 is retained at the first diameter D1 by the third holding members 302.

The first holding members 102 have been moved further in the contraction direction C. In particular, the first holding members 102 have been moved into a pick-up position between the green tire carcass 9 or the tire components 90, 91, 92 and the circumferential retaining surface 70 of the first tire building drum 7.

As is shown in FIG. 2D, the first holding members 102 have been inserted between the green tire carcass 9 and the circumferential retaining surface 70 of the first tire building drum 7. In particular, the first holding members have been moved in the axial direction X towards and/or into contact with the axial ends of the tire carcass 9. The first holding members 102 may for example be movable relative to the frame 110 of the first transfer ring 100 in the axial direction ring in X. Additionally or alternatively, the first transfer rings 100 may be movable relative to one another in the axial direction X.

Preferably, the first holding members 102 are further moved from the pick-up position into the expansion direction E towards a support position. In said support position, the first holding members 102 engage the axial ends of the green tire carcass 9 in the radial outward direction R2. In other words, the axial ends of the green tire carcass 9 are now supported on the forks, scoops, lifters or first holding members 102. Optionally, the first holding members 102 are further displaced from the support position in the expansion direction E to stretch the green tire carcass 9 in the radial outward direction R2.

As is shown in FIG. 2E, the transfer rings 100, 200, 300 are simultaneously and/or synchronously moved in the axial direction X to transfer the green tire carcass 9 away from the first tire building drum 7. Preferably, the green tire carcass 9 is subsequently transferred to the shaping drum or second tire building drum 8.

Alternatively, the steps of FIGS. 2D and 2E may be combined. In particular, following the situation of FIG. 2C, the transfer rings 100, 200, 300 are simultaneously and/or synchronously moved in the axial direction X to transfer the green tire carcass 9 away from the first tire building drum 7. Subsequently or simultaneously, the first holding members 102 are positioned in a position radially inward R1 with respect to the axial ends of the green tire carcass 9. The first holding members 102 are than moved from the pick-up position into the expansion direction E towards a support position for engaging the axial ends of the green tire carcass 9 in the radial outward direction R2.

Optionally, the method further includes an adjustment step of moving the holding members 102, 202, 302 in the radial inward direction R1 or the radial outward direction R2 to adjust a radial position of said elements to the first diameter D1 and/or the second diameter D2 of the first tire building drum 7. Said adjustment step may be performed while non-transfer-related operations are performed on and/or by the first tire building drum 7 and/or the second tire building drum 8. Said non-transfer related operations may for example include: expanding and/or contracting the tire first tire building drum 7 or the second tire building drum 8; applying one or more of the tire components 90, 91, 92 around the first tire building drum 7 or the second tire building drum 8; stitching one or more of the tire components 90, 91 on the circumferential retaining surface 70 of the first tire building drum 7 or the shaping surface 80 of the second tire building drum 8; turning up one or more of the tire components 90, 91 at the shaping drum or second tire building drum 8, preferably folding at least the inner line 90 around the bead or bead-apex 92 by means of the turn-up arms or bladders; and/or shaping the green tire carcass 9 at the shaping drum or second tire building drum 8.

In summary, the invention relates to a transfer ring 100, 200, 300 for transferring one or more tire components 90, 91, 92, wherein the transfer ring 100, 200, 300 comprises a frame 110 that extends circumferentially about a central axis A defining a central aperture 109 for receiving a tire building drum 7, 8, wherein the transfer ring 100, 200, 300 comprises a plurality of holding members 102, 202, 302 distributed circumferentially about the central axis A for holding the one or more tire components 90, 91, 92,
wherein the transfer ring 100, 200, 300 further comprises a radial drive 2, 402, 502 for moving the holding members 102, 202, 302 with respect to the frame 110 in a contraction direction C and an expansion direction E,
wherein the radial drive 2, 402, 502 comprises, for at least one holding member 102, 202, 302 of the plurality of holding members 102, 202, 302, a first drive member 21, 421, 521 that is arranged for translational movement with respect to the frame 110 and a second drive member 22, 422, 522 that is arranged for translational movement with respect to the first drive member 21, 421, 521.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

### REFERENCE NUMERALS

1 tire building assembly
2 radial drive
21 first drive member
22 second drive member
23 first attachment member
24 second attachment member
25 first side
26 second side
29 fastener
3 actuator
4 first transmission
40 belt
41 first pulley
42 second pulley
43 first belt part
44 second belt part
45 third belt part
46 fourth belt part
5 second transmission
51 pinion
52 gear rack
53 planet gear
7 first tire building drum or carcass drum
70 circumferential retaining surface
8 second tire building drum shaping drum
80 circumferential shaping surface
9 green tire carcass
90 inner liner
91 cord reinforced breaker ply
92 bead-apex
100 first transfer ring or fork ring
102 first holding member, fork or scoop
108 inner rim
109 central aperture
110 frame
200 second transfer ring or bead setter
202 second holding member, or bead holding member
300 third transfer ring or magnet ring
302 third holding member or central holding member
402 alternative radial drive
421 alternative first drive member
422 alternative second drive member
502 further alternative radial drive
521 further alternative first drive member
522 further alternative second drive member
503 further actuator
505 control unit
A central axis
B1 first pulley axis
B2 second pulley axis
C contraction direction
D1 first diameter
D2 second diameter
E expansion direction
R1 radial inward direction
R2 radial outward direction
X axial direction

1. A transfer ring for transferring one or more tire components, wherein the transfer ring comprises a frame that extends circumferentially about a central axis defining a central aperture for receiving a tire building drum, wherein the transfer ring comprises a plurality of holding members for holding the one or more tire components during transfer of said one or more tire components by the transfer ring, wherein said holding members are distributed circumferentially about the central axis, wherein the transfer ring further comprises a radial drive for moving the holding members with respect to the frame in a contraction direction towards the central axis and in an expansion direction away from the central axis, wherein the radial drive comprises, for at least one holding member of the plurality of holding members, a first drive member that is arranged for translational movement with respect to the frame with at least a vector component in the contraction direction and the expansion direction and a second drive member, supported by the first drive member, that is arranged for translational movement with respect to the first drive member with at least a vector component in the contraction direction and the expansion direction.

2. The transfer ring according to claim 1, wherein the radial drive comprises a first transmission that is arranged for mechanically coupling a movement of the first drive member with respect to the frame to a movement of the second drive member with respect to the first drive member.

3. The transfer ring according to claim 2, wherein the first transmission is arranged to impart a movement to the second drive member with respect to the first drive member in response to a movement of the first drive member with respect to the frame.

4. The transfer ring according to claim 2, wherein the first transmission is arranged to impart a movement to the second drive member in the contraction direction in response to a movement of the first drive member in the contraction direction, and wherein the first transmission is arranged to impart a movement to the second drive member in the expansion direction in response to a movement of the first drive member in the expansion direction.

5. The transfer ring according to claim 2, wherein a transmission ratio between the movement of the first drive member with respect to the frame and the movement of the second drive member with respect to the first drive member is fixed.

6. The transfer ring according to claim 5, wherein the transmission ratio between the movement of the first drive member with respect to the frame and the movement of the second drive member with respect to the frame is at least 2:1.

7. The transfer ring according to claim 2, wherein the first transmission comprises a belt that is freely rotatable with respect to the first drive member, wherein the belt is, at a first side of the first drive member, fixedly connected to the frame, and wherein the belt is, at a second side of the first drive member opposite to the first side, fixedly connected to the second drive member, such that a movement of the first drive member with respect to the frame causes the second drive member to move with respect to the first drive member in the same direction.

8. The transfer ring according to claim 7, wherein the second drive member extends in line with the belt.

9. The transfer ring according to claim 7, wherein the second drive member extends parallel to the belt.

10. The transfer ring according to claim 1, wherein the radial drive comprises an actuator for actuating the movement of the first drive member with respect to the frame, and wherein the radial drive further comprises a second transmission for mechanically coupling a movement of the actuator to the movement of the first drive member.

11. The transfer ring according to claim 10, wherein the second transmission comprises a gear rack that is fixedly connected to the first drive member and an associated pinion that is mounted to the frame, wherein the pinion is mechanically coupled to the actuator.

12. The transfer ring according to claim 11, wherein the second transmission further comprises a planet gear for engaging multiple pinions in rotation simultaneously, and wherein the actuator is arranged to drive the planet gear in rotation.

13. The transfer ring according to claim 10, wherein the actuator is a linear drive, preferably a linear servomotor, or a servo controlled spindle.

14. The transfer ring according to claim 1, wherein the radial drive comprises a first actuator for driving the movement of the first drive member with respect to the frame and a second actuator for driving the movement of the second drive member with respect to the first drive member.

15. The transfer ring according to claim 14, wherein the radial drive further comprises a control unit that is electronically or functionally connected to the first actuator and the second actuator, wherein the control unit is arranged for electronically coupling a movement of the first drive member with respect to the second drive member to a movement of the first drive member with respect to the frame.

16. The transfer ring according to claim 15, wherein the control unit is arranged to control the first actuator and the second actuator such that a ratio between the movement of the first drive member with respect to the frame and the movement of the second drive member with respect to the first drive member is fixed.

17. The transfer ring according to claim 14, wherein at least one of the first actuator and the second actuator is a linear drive, or a servomotor.

18. The transfer ring according to claim 1, wherein the first drive member is linearly movable with respect to the frame in a radial inward direction towards and perpendicular to the central axis, and a radial outward direction opposite to said radial inward direction.

19. The transfer ring according to claim 1, wherein the second drive member is linearly movable with respect to the first drive member in a radial inward direction towards and perpendicular to the central axis, and a radial outward direction opposite to said radial inward direction.

20. The transfer ring according to claim 1, wherein the at least one holding member is supported by the second drive member.

21. The transfer ring according to claim 20, wherein the holding member is fixedly connected to the second drive member.

22. The transfer ring according to claim 1, wherein, in an expanded state, the first drive member and the second drive member extend outside of the central aperture in the radial outward direction.

23. The transfer ring according to claim 1, wherein the holding member comprises a fork, a scoop or a lifter that is arranged to be inserted between a circumferential surface of the tire building drum and the one or more tire components.

24. The transfer ring according to claim 1, wherein the radial drive comprises, for each holding member of the plurality of holding members, a first drive member and a second drive member, supported by a respective first drive member.

25. The transfer ring according to claim 24, wherein the radial drive is arranged to drive the first drive members simultaneously or synchronously in the contraction direction and the expansion direction.

26. A tire building assembly for transferring one or more tire components, wherein the assembly comprises two first transfer rings for lifting a respective axial end of the one or more tire components, two second transfer rings, positioned between the two first transfer rings, for retaining a bead or bead-apex, and a third transfer ring, positioned between the two second transfer rings, for retaining a central portion of the one or more tire components, wherein at least one of the first transfer rings, the second transfer rings and the third transfer ring is a transfer ring according to claim 1.

27. A method for transferring one or more tire components using a transfer ring according to claim 1, wherein the method comprises the steps of moving the holding members relative to the frame in the contraction direction and/or the expansion direction.

28. The method according to claim 27, wherein the holding members are moved relative to the frame in the contraction direction or the expansion direction while the tire building drum is received within the central aperture of the transfer ring.

29. The method according to claim 27, wherein a radial position of the holding members is adjusted to a diameter of the tire building drum while the transfer ring is spaced apart from said tire building drum along the central axis.

30. The method according to claim 27, wherein the holding members are inserted at a position radially inward of the one or more tire components in an axial direction parallel to the central axis while the transfer ring is spaced apart from said tire building drum in said axial direction.

31. The method according to claim 27, wherein the holding members are moved relative to the frame in the contraction direction or the expansion direction while non-transfer-related operations are performed on or by the tire building drum.

32. The method according to claim 31, wherein the non-transfer related operations include: expanding or contracting the tire building drum;
applying one or more tire components around the tire building drum; stitching one or more tire components on said tire building drum; turn-up of one or more tire components at the tire building drum; or shaping the tire components at the tire building drum.
